(19) United States
(12) Patent Application Publication
(10) Pub. No.: US 2010/0077685 A1
(43) Pub. Date: Apr. 1, 2010

(54) VENEER PANEL

(76) Inventor: Clinton Joe Andersen, JR., Chandler, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/568,969

(22) Filed: Sep. 29, 2009

Related U.S. Application Data
(60) Provisional application No. 61/101,080, filed on Sep. 29, 2008.

(51) Int. Cl. E04F 13/073; E04F 19/00; B29C 33/40

(52) U.S. Cl. 52/461; 264/220

(57) ABSTRACT

A veneer panel is configured for installation on an H-block column. The veneer panel comprises a substantially vertical surface abutting a first surface of the H-block column, a substantially horizontal surface connected to the substantially vertical surface and abutting a second surface of the H-block column, a first substantially vertical lip attached to a first vertical edge of the substantially vertical surface and configured to abut a third surface of the H-block column, and a second substantially vertical lip attached to a second vertical edge of the substantially vertical surface and configured to abut a fourth surface of the H-block column. The substantially vertical surface, the substantially horizontal surface, the first substantially vertical lip, and the second substantially vertical lip are molded in one piece and are operatively coupled in order to cause a moment of force at the base of the H-block column to be less than the moment of force would be without at least one of the substantially horizontal surface, the first substantially vertical lip, and the second substantially vertical lip. Further, the substantially vertical surface, the substantially horizontal surface, the first substantially vertical lip, and the second substantially vertical lip may be molded in one piece to facilitate ease of installation of the veneer panel.

### CROSS REFERENCE TO RELATED APPLICATIONS

This application claims priority to and the benefit of U.S. Provisional Ser. No. 61/101,080 filed Sep. 29, 2008 and entitled, “Veneer Panel,” the entirety of which is hereby incorporated herein by reference.

### FIELD OF THE INVENTION

The present invention relates to a veneer panel, and more particularly to a veneer panel with horizontal and vertical surfaces configured to be hung on a column.

### BACKGROUND

Stone veneer (synthetic, faux, natural, etc.) and other types of veneer (e.g., wood, metal, plastic, fiberglass, and the like) are often used in building design to enhance the appearance of a structure. Existing stone veneer is frequently installed over individual bricks or blocks (“brick-by-brick”), and is also less frequently installed as panels. Brick-by-brick configurations are generally mortared into place one piece at a time resulting in substantial time and cost for installation. Panels of brick veneer are generally first cut to a desired size and shape, and are then fastened into place by screw, nail or glue. In some cases, the panels are connected to each other by wire or mortar and wire/fiber mesh, or they are bonded together using the same or similar mixture as the panel itself

After installation, the panels are ground and retextured to hide the seams between the panels. Some panels may be designed to cover a particular size of a brick or block, but these panels are then individually attached to the brick or block and then to neighboring panels. Such installation options are time consuming and expensive and may require professional installation. It is therefore desirable to develop a veneer panel that is easier to install and that is less expensive than installation of existing veneer panels.

Additionally, existing stone veneer is sometimes installed on walls or other vertical surfaces. Adding weight to a vertical surface causes an imbalance of vertical force, causing a moment of force that stresses the column from top to bottom, culminating in a substantial moment of force at the foundation of the column thereby resulting in an increased rotational force at the base or other support of the vertical surface (see, e.g., forces F_{g}, R₁, R₂, and M_{g} in FIGS. 1A-1F). Because stone veneer is often installed after the vertical surface is constructed, the vertical surface and/or the foundation upon which it is installed may not be designed to bear these additional forces, and the vertical surface may be subject to structural failure,

For example, the vertical surface may buckle at some point along the vertical surface, or the vertical surface may detach, tip and/or fall away from the foundation. If a vertical surface is designed to withstand a particular horizontal force (e.g., a cinderblock wall may be built to withstand 70 mile-per-hour winds), and then additional weight is added to that vertical surface, the increased rotational force may cause the vertical surface to fail earlier than designed (e.g., 40 mile-per-hour winds may be sufficient to topple the cinderblock wall). Therefore, it is desirable to develop a veneer panel that strengthens the structure of the vertical surface, for example, by increasing the area moment of inertia of a cross section of the vertical surface and/or by reducing the rotational reaction force at the base of the vertical surface.

Furthermore, some stone veneer, particularly “brick-by-brick” installations (see, e.g., FIGS. 1A-1C), may also fall off a piece at a time. Using regular panels may avoid this kind of fracturing, however, such substantially tough paneling is also substantially heavier, thereby producing a larger moment of force at the base of the column such that it would be easier for the vertical surface to fall or tip over. Therefore, it is desirable to develop a veneer panel that not only reduces structural failure of the veneer panel itself, but that also strengthens the structure of the vertical surface reduces the risk of premature failure of the vertical surface.

### SUMMARY

According to various embodiments, a veneer panel hangs on an H-block column that has a column width and a column height. The veneer panel comprises a substantially vertical surface that abuts a first vertical surface of the H-block column and extends approximately a dimension A (as illustrated in FIGS. 4A-5D) past a top of the H-block column. The substantially vertical surface is configured to be longer than the column height by approximately the dimension A, and the substantially vertical surface has a thickness of approximately a dimension E and a width of approximately a dimension C.

The veneer panel further comprises a substantially horizontal surface attached to the substantially vertical surface. The substantially horizontal surface abuts a top of the H-block column and extends from the substantially vertical surface by approximately a dimension F, and the substantially horizontal surface has a thickness of approximately a dimension A.

In various embodiments, the veneer panel comprises a first substantially vertical lip attached to a first vertical edge of the substantially vertical surface and configured to abut a second vertical surface of the H-block column. The first substantially vertical lip extends from the substantially vertical surface by approximately a dimension G, and the first substantially vertical lip has a thickness of approximately a dimension B. The veneer panel further comprises a second substantially vertical lip attached to a second vertical edge of the substantially vertical surface and configured to abut a third vertical surface of the H-block column. The second substantially vertical lip extends from the substantially vertical surface by approximately the dimension G, and the second substantially vertical lip has a thickness of approximately the dimension B. In an embodiment, the first substantially vertical lip is separated from the second substantially vertical lip by approximately a dimension D.

In accordance with various embodiments, a veneer panel may be configured for installation on an H-block column. The veneer panel comprises a substantially vertical surface abutting a first surface of the H-block column, a substantially horizontal surface connected to the substantially vertical surface and abutting a second surface of the H-block column, a first substantially vertical lip attached to a first vertical edge of the substantially vertical surface and configured to abut a third surface of the H-block column, and a second substantially vertical lip attached to a second vertical edge of the substantially vertical surface and configured to abut a fourth surface of the H-block column. The substantially vertical surface, the substantially horizontal surface, the first substantially vertical lip, and the second substantially vertical lip are molded in one piece and .are operatively coupled in order to cause a moment of force at the base of the H-block column to be less than the moment of force would be without at least one of the substantially horizontal surface, the first substantially vertical lip, and the second substantially vertical lip. Further, the substantially vertical surface, the substantially horizontal surface, the first substantially vertical lip, and the second substantially vertical lip may be molded in one piece to facilitate ease of installation of the veneer panel.

Further, according to an embodiment, the substantially horizontal surface exerts a vertical force on the H-block column, wherein the vertical force is configured to act substantially through the center of the H-block column. The substantially vertical surface exerts a horizontal force on the H-block column that increases asymptotically as the distance from the top of the H-block column increases. The substantially vertical surface, the substantially horizontal surface, the first substantially vertical lip, and the second substantially vertical lip are operatively coupled to at least one of maintain or increase a level of an external force to which the H-block column is subjected without failure of the H-block column. In an embodiment, the level of the external force to which the H-block column is subjected without failure of the H-block column is greater than it would be without the substantially horizontal surface. Additionally, in various embodiments, the substantially vertical surface, the substantially horizontal surface, the first substantially vertical lip, and the second substantially vertical lip are operatively coupled to increase an area moment of inertia associated with the H-block column and the veneer panel.

According to various embodiments, a method of manufacturing a veneer panel comprises forming a first mold encasement that is configured to provide a desired texture of the veneer panel. The mold encasement is dimensioned in accordance with a top and a side of a cinderblock H-block column, and the first mold encasement is configured to produce a substantially vertical surface, a substantially horizontal surface, a first substantially vertical lip, and a second substantially vertical lip of the veneer panel. The method further comprises placing a molding material into the first mold encasement and securing a second mold encasement to the first mold encasement to facilitate forming the veneer panel. The veneer panel formed in such a manner is configured to be hung on the cinderblock H-block column, producing minimal stress, in the form of a moment of force, at the base of the column, while increasing the area moment of inertia associated with the cinderblock H-block column and the veneer panel.

### BRIEF DESCRIPTION OF THE DRAWINGS

The subject matter of the present invention is particularly pointed out and distinctly claimed in the concluding portion of the specification. The invention, however, both as to structure and method of operation, may best be understood by reference to the following description taken in conjunction with the claims and the accompanying drawing figures, in which like parts may be referred to by like numerals.

FIG. 1A illustrates a prior art brick-by-brick veneer installed on a vertical surface resulting in gravitational forces on the vertical surface and the reaction force from the column foundation;

FIG. 1B illustrates resulting moments of force generated by each piece of prior art stone veneer along a column, and the cumulative reaction moment that the base of the column exerts against the moment of force caused by the stone veneer according to the prior art;

FIG. 1C illustrates both the reaction force and the reaction moment that is generated by the column foundation according to the prior art;

FIG. 1D illustrates a prior art panel veneer installed on a vertical surface resulting in gravitational forces on the vertical surface, and the reaction force from the column foundation;

FIG. 1E illustrates resulting moment of force generated by each piece of the prior art veneer panels along the column, and the cumulative reaction moment that the base of the column exerts against the moment of force caused by veneer panels according to the prior art;

FIG. 1F illustrates both the reaction force and the reaction moment that is generated by the column foundation according to the prior art;

FIG. 2A illustrates a veneer panel according to an embodiment of the present invention resulting in the gravitational forces that act more towards the center of the column, instead of at the column surface, thereby creating more balanced reaction forces from the column foundation.

FIG. 2B illustrates the reaction forces of the horizontal and vertical surfaces of the column and the reaction moments of force, where most of the weight of the veneer panel is delivered through vertical force acting on the horizontal top of the column, resulting in a decreased reaction moment of force at the base of the column;

FIG. 2C illustrates both the more-balanced reaction forces and the reduced reaction moment that is generated by the column foundation according to an embodiment of the present invention;

FIG. 3A illustrates a perspective view of a veneer panel according to an embodiment of the present invention;

FIG. 3B illustrates another perspective view of a veneer panel according to an embodiment of the present invention;

FIG. 4A illustrates a plan view of a veneer panel on a column according to an embodiment of the present invention;

FIG. 4B illustrates a side sectional view of the veneer panel of FIG. 4A;

FIG. 4C illustrates a detail view of the veneer panel of FIG. 4A;

FIG. 4D illustrates a top sectional view of the veneer panel of FIG. 4A;

FIG. 5A illustrates a plan view of a veneer panel according to an embodiment of the present invention;

FIG. 5B illustrates a side view of the veneer panel of FIG. 5A;

FIG. 5C illustrates a bottom view of the veneer panel of FIG. 5A;

FIG. 5D illustrates a top view of the veneer panel of FIG. 5A;

FIGS. 6A-6D illustrate textures for veneer panels according to various embodiments of the present invention; and

FIGS. 7A-7B illustrate two architectural designs according to embodiments of the present invention.

FIG. 8A-8B illustrate side views of veneer panels according to embodiments of the present invention.

### DETAILED DESCRIPTION

The following description is of exemplary embodiments of the invention and is not intended to limit the scope or applicability of the invention in any way. Rather, the following description is intended to provide convenient illustrations for implementing various embodiments of the invention. Other configurations, materials, shapes, designs, and the like may be employed without departing from the scope of the present invention. As will become apparent, various other changes may be made to the methods described in these embodiments without departing from the spirit and scope of the invention.

Exemplary embodiments of the present invention comprise a veneer panel that is configured to cover one or both sides of a wall, column, support, and/or portions thereof. For example, the veneer panel may be configured to cover a cinderblock wall column to give the column an appearance of stacked stone, field stone, rock, river rock, brick, wood, bamboo, fossils, plants, ivy, moss, stucco, concrete, paneling or any other aesthetic appearance. Although the present disclosure will focus on embodiments of the veneer panel that are configured to cover the wall column of a cinderblock wall, it should be understood that the veneer panel may be configured to cover other structures, and that such other structures are contemplated within the scope of this disclosure.

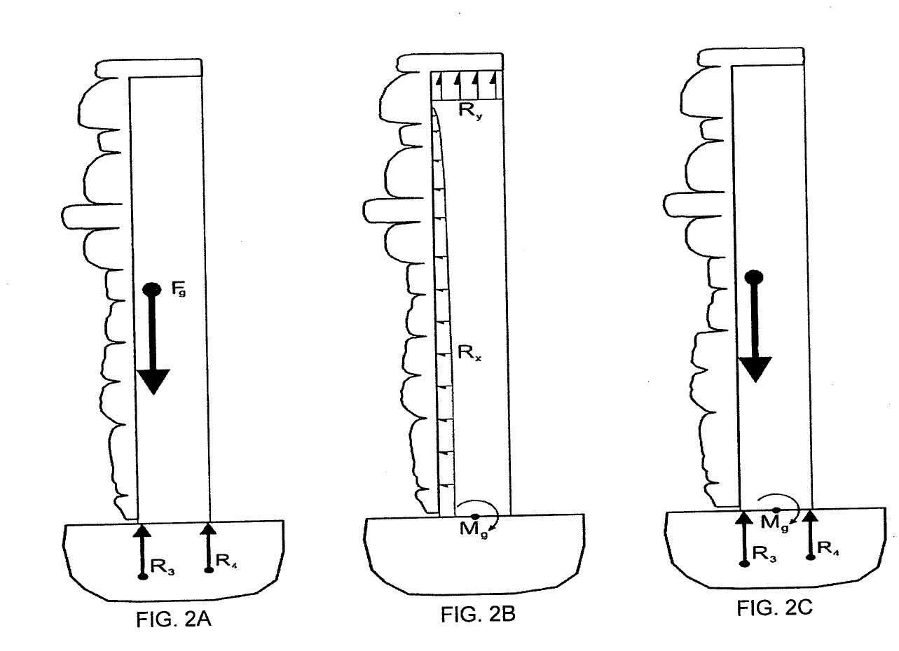

In an exemplary embodiment, and with reference to FIGS. 2A-2C, 3A, 3B and 4A-4D, a veneer panel 10 comprises a substantially vertical surface 20 and a substantially horizontal surface 15. The substantially vertical surface 20 is configured to abut a vertical surface of a wall column 30 or other structure that is configured to be covered by the veneer panel. The substantially horizontal surface 15 is configured to abut a horizontal surface 35 of the top of the wall or other structure. The substantially vertical surface 15 and the substantially horizontal surface 20 are configured to be manufactured as one monolithic piece or joined or otherwise attached together to form approximately a ninety degree angle, creating a veneer panel 10 is substantially L-shaped. As such, and with continued reference to FIG. 2, the veneer panel is configured to hang on the wall column 30 so that the weight of the panel exerts a vertical force on the column with little or no horizontal force exerted.

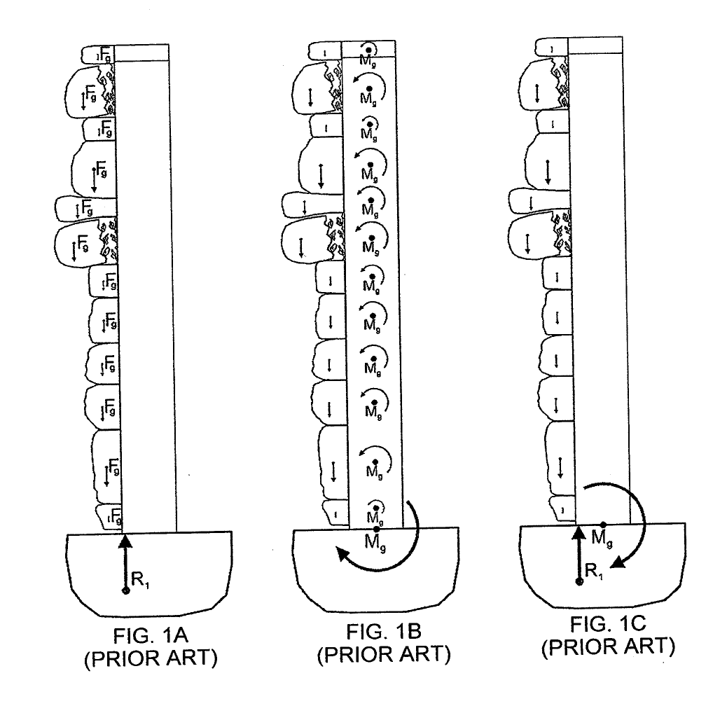

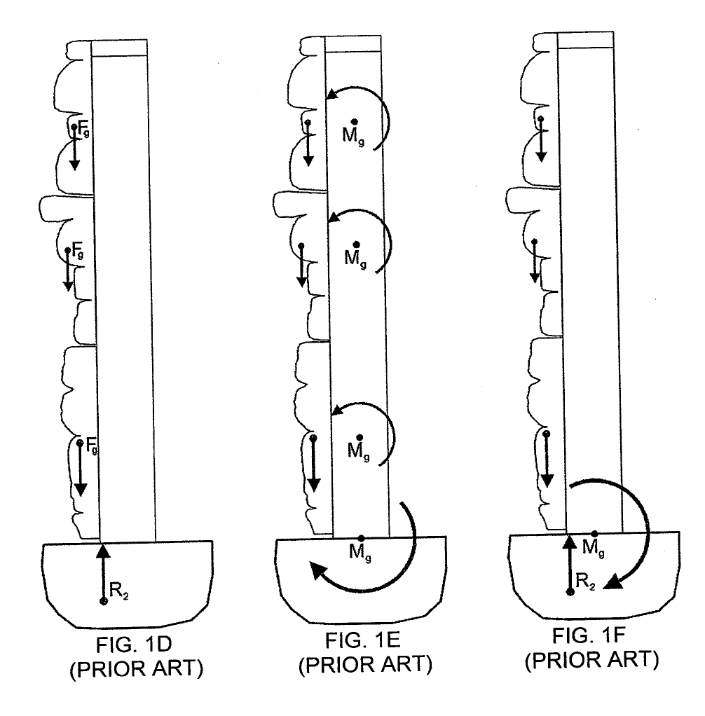

In this regard, as can be seen by comparing prior art FIGS. 1A-1F with embodiments as illustrated in FIGS. 2A-2C, veneer panel 10 overcomes difficulties associated with the prior art. For example, substantially horizontal surface 15 is configured to support a substantial portion of the weight of vertical surface 20, resulting in horizontal surface 35 bearing a substantial portion the weight of veneer panel 10.

With horizontal surface 35 bearing this weight (e.g., reaction force R_{y}), the gravitational force (F_{g}) resulting from the veneer panel 10 acts more through the center of column 30, as opposed to at the vertical surface 37 of column 30 (as in the prior art, e.g., FIGS. 1A-1F). Because the gravitational force acts more through the center of column 30, the resultant reactionary forces (R₃, R₄) are more evenly distributed at the base of column 30, resulting in a reduced moment of force (M_{g}) at the base of column 30. For example, the moment of force at the base of the H-block column may be less than the moment of force would be without at least one of the substantially horizontal surface, the first substantially vertical lip, and the second substantially vertical lip.

A moment of force may be defined as the tendency of a force to rotate an object about an axis, fulcrum, or pivot. In the way a linear force may be defined as a push or a pull motion, a moment of force or torque can be defined of as a force that induces a twisting motion. In other words, a moment of force defines the magnitude of force applied that may cause an object to rotate. For example, a wrench or spanner may be utilized to twist a nut or a bolt. Moments of force are calculated by multiplying the external vector forces (loads or reactions) by the vector distance at which they are applied (e.g., the length of the wrench or spanner handle). The moment of a force F about a point O (called the moment center) is equal to the magnitude of the force F multiplied by the perpendicular distance d (called the moment arm) from O to the line of action of the force. Moments of force and torques are measured as a force multiplied by a distance so they have as units of, e.g., Newton-meters (N·m), or foot-pounds force (ft·lbf).

Some moment of force may be present in column 30 because of some horizontal reaction forces (Rx) that increase asymptotically towards the base of the column, and that are caused by the substantially vertical surface 20 of veneer panel 10, but the horizontal reaction forces and resulting moment of force are minimal. Because the moment of force at the base of column 30 is reduced as compared with the prior art, column 30 with veneer panel 10 according to embodiments of the present invention can withstand a greater external horizontal force (e.g., wind) applied to column 30 than columns with prior art veneer can withstand.

For example, if a cinderblock column is designed to withstand 70 mile-per-hour winds without any veneer paneling, the prior art veneer may cause the column to only be able to withstand a 40 mile-per-hour wind before the column fails, because of the increased reactionary moment of force at the base or foundation of the column. On the other hand, veneer panel 10, according to various embodiments, overcomes this deficiency in the prior art because the reactionary moment of force is reduced, enabling the column to withstand a greater horizontal force. In fact, veneer panel 10 may actually enable column 30 to withstand greater external horizontal forces that a column without veneer, because the weight of veneer panel 10 that is distributed more towards the center of column 30 may compress column 30, thereby making column 30 more compact and more resistant to failure.

In accordance with various embodiments, veneer panel 10 may be configured to maintain and/or increase the area moment of inertia of a cross section of wall column 30 such that the wall column's propensity to buckle and/or otherwise fail over is reduced. The area moment of inertia may be defined as a property of shape of the cross-section of a beam or column that can be used to predict the resistance of the beam or column to bending and deflection. The deflection of a column under load depends not only on the load, but also on the geometry of the column's cross-section.

For purposes of illustration, using the same theoretical cross section for brick-by-brick faux rock (see FIGS. 1A, 1B & 1C), traditional panels (FIGS. 1D, 1E, 1F) and veneer panel 10 according to various embodiments of the present invention (FIGS. 2A, 2B, & 2C), a comparison can be made between the resulting stresses made on column 30 from each of the three faux stone methods. Each method results in some amount of moment of force exerted on the column at its base.

When calculating the moment of force exerted by traditional paneling (e.g., no substantially horizontal surface), the density of the paneling is assumed substantially equal to the density of the veneer panel 10 itself. That being the case, veneer panel 10, because of it's unique upside down “L” configuration, exerts more vertical force on the column than the traditional panel (which exerts essentially all of its vertical force at the face of the column). And even though veneer panel 10 has the added weight of substantially horizontal surface 15 with which it hangs on column 30, the veneer panel 10 may produce approximately 30-50% less moment of force on column 30 at its base than traditional prior art panels.

When calculating the moment of force exerted by a traditional “brick-by-brick” method (e.g., adhering individual bricks to the surface of a column), it may be assumed that the lightweight faux rocks are less dense (e.g., two-thirds the density) than the material used in veneer panel 10 or traditional panels. Even so, the resulting moment of force exerted by this traditional prior art lightweight faux rock may be the same or greater than the moment of force exerted by veneer panel 10. However, prior art brick-by-brick installations are subject to increased rates of failure, because each of the bricks may detach and/or separate from the column. Veneer panel 10, according to various embodiments, overcomes this deficiency in the prior art because of the solid body construction of veneer panel 10, and veneer panel 10 overcomes this deficiency without compromising the structural integrity of column 30, as discussed above.

It should be noted that these simple calculations actually underestimate the structural benefits of veneer panel 10 in the following three ways. First, because of dimension “G”, lips 22 and 24 butt up against the adjacent wall sections. This takes some of the horizontal pressure off the column. Even though the magnitude of this pressure may be small, because it is applied to both sides of the column, its effect on reducing the overall moment of force is significant. Second, as has been noted, the vertical cross-section of veneer panel 10 allows it to at least partially wrap around three sides of column 30. This design provides a greater area moment of inertia to the now combined column & veneer panel 10. Veneer panel 10, according to various embodiments, is configured to give greater stability to a column even if the cinder blocks were simply stacked one on top of the other without mortar. For example, the weight of veneer panel 10 would effectively compress the cinderblocks, thereby adding strength and stability to the column. Third, and similar to the previous example, the column is actually given added strength because of the substantial vertical force that veneer panel 10 exerts on it, similar to the way that post-tension concrete adds strength to a system. Neither the light weight faux rock, nor traditional panel prior art methods adds strength in this manner.

Cinderblock columns 30 may be formed from a plurality of “H-blocks” 40 (cinderblocks having a cross-section of an “H” shape) stacked on top of each other, and a single veneer panel may be configured to cover all of the H-blocks 40 existing in one column, such that attaching separate panels to a portion of the column may not be necessary.

The substantially horizontal surface 15 of the veneer panel 10 may be configured to provide vertical, horizontal, and/or frictional support to the veneer panel. The substantially vertical surface 20 of the veneer panel 10 may similarly be configured to provide vertical, horizontal, and/or frictional support to the veneer panel. In other embodiments, the veneer panel 10 may not provide frictional support, and is configured to be affixed to the cinderblock column without frictional support.

In exemplary embodiments, an L-shaped veneer panel is configured to hang on the cinderblock column without glue, adhesives, nails, screws, fastening mechanisms or other means for securing the veneer panel to the cinderblock column. In still other embodiments, glue or other adhesives or fasteners may be used to prevent theft, vandalism, or accidental removal, or to provide more secure attachment to the column. For example, the adhesive may be applied at the top 35 of cinderblock column 30 and/or to the side 37 of the column 30 that abuts the substantially vertical surface 20.

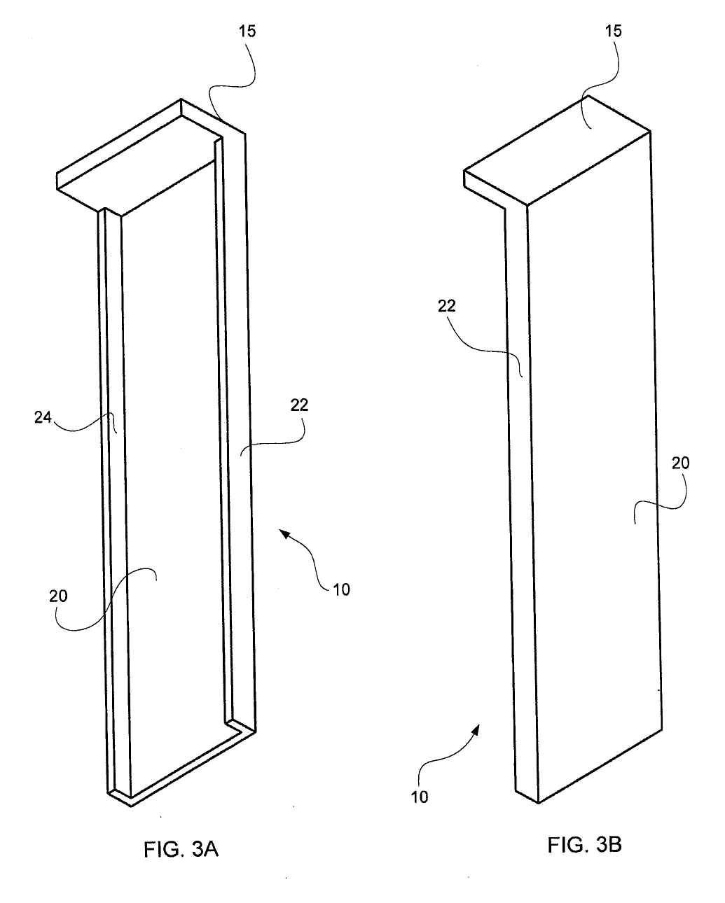

In accordance with still other embodiments, the veneer panel may comprise more than one substantially vertical surface. For example, where the veneer panel is configured to cover more than one vertical surface of a column, the veneer panel may comprise other substantially vertical surfaces configured to cover the other vertical surfaces of a column. These other substantially vertical surfaces may be formed as a single piece together with the substantially horizontal surface of the panel. In other embodiments, the other substantially vertical surfaces may be formed separately and then subsequently attached to the veneer panel. In certain embodiments, it may be desirable to cover the front and the back of a column, and the veneer panel according to the present invention may be configured to cover both of these surfaces. With reference to FIGS. 3A and 3B, additional substantially vertical surfaces 22 and 24 are configured to abut the sides of cinderblock column 30 in order to provide additional support to the column and/or to enhance the structural characteristics of veneer panel 10.

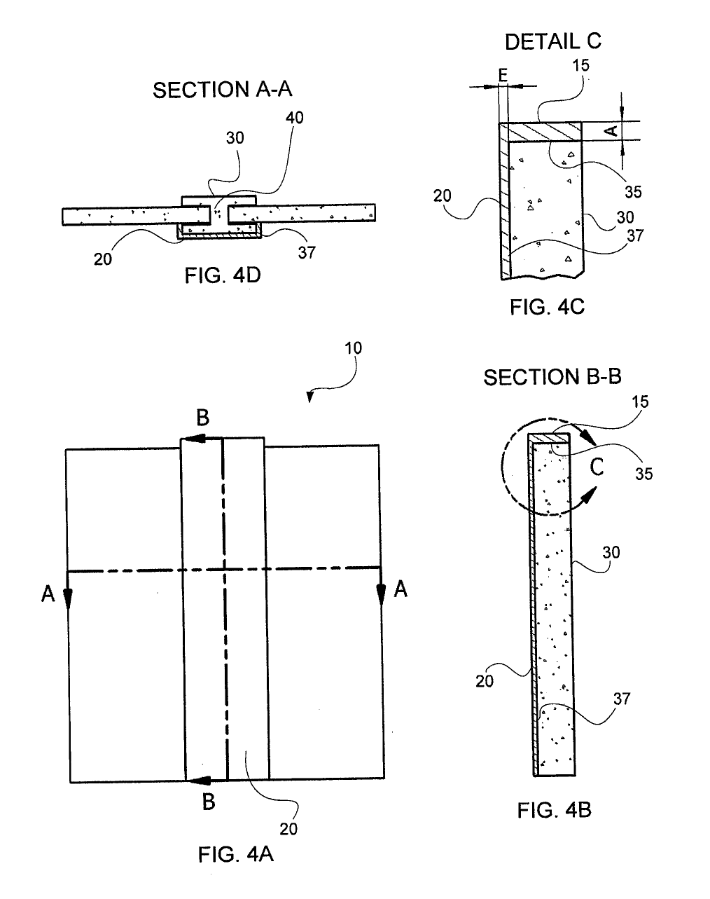

In an exemplary embodiment, and with continued reference to FIGS. 3A and 3B, where the veneer panel is configured to cover columns 30 of a cinderblock wall, the veneer panel may comprise lips 22, 24 that protrude from and are adjacent to the substantially vertical surface of the panel. Columns in cinderblock walls may protrude from the surface of the wall, and the vertically oriented lips may be configured to cover the protruded sides of the columns, as illustrated in FIGS. 3A and 3B and SECTION A-A of FIG. 4D. In such embodiments, the veneer panel may be configured to hug around the sides as well as the top of the column. The lips 22, 24 may be formed together with the substantially vertical surface, or they may be formed separately and then subsequently attached.

In other embodiments, the veneer panel may be configured to slide over the top of the column in order to provide greater stability and/or visually enhance the appearance of the wall or veneer panel. In such embodiments, the veneer panel may comprise additional vertically-oriented portions (resulting in a partial U-shape instead of an L-shape).

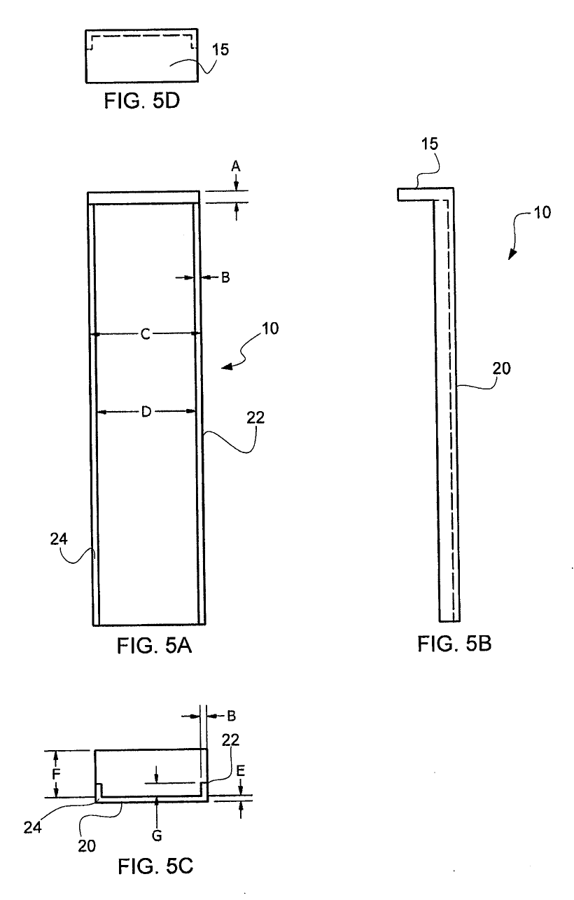

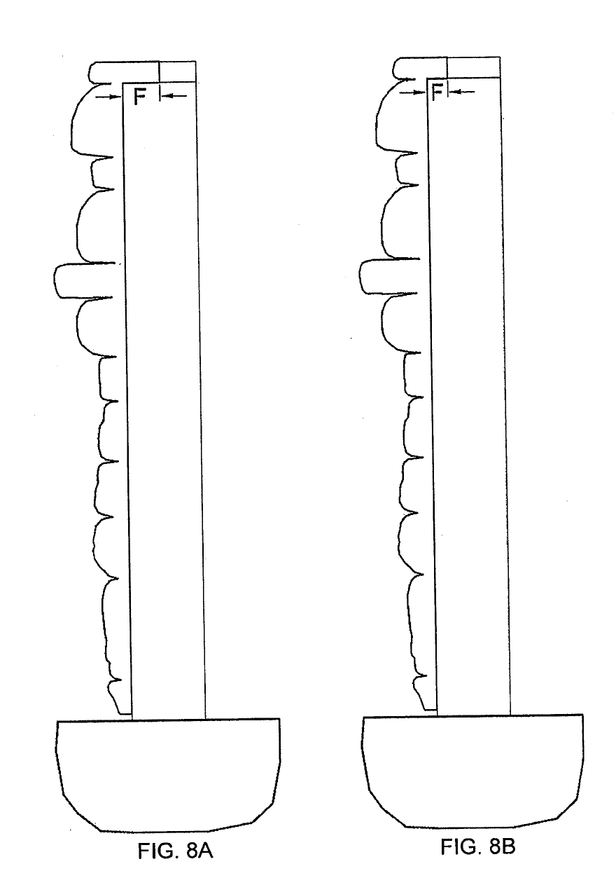

Although it should be understood that the veneer panel as disclosed herein may be configured to cover any horizontal surface, a specific example of a veneer panel will now be disclosed that is designed to be installed over a standard H-block of a cinderblock wall. For example, with reference to FIGS. 5A-5D, a typical H-block may have dimensions D and F, or substantially equal to D and F, such that veneer panel 10 is configured to cover the H-block. In an embodiment, dimension D is approximately 16 inches, and dimension F is approximately 8 inches. In other embodiments, as shown in FIGS. 8A and 8B, dimension F may not necessarily cover the entire top (horizontal) surface of the column. Dimension F may only cover half of the column, as shown in FIG. 8A. It an exemplary embodiment, dimension F should be at least 2″ to 2.25″ over the top surface of the column. In various embodiments, fasteners (glue, etc.) may be utilized to prevent accidental removal of the panel.

Columns of H-blocks may vary in height, depending on the construction of the cinderblock wall and the desired height of the wall. The total height of veneer panel 10 may be adjusted before or after manufacturing to achieve the height of a particular column. Dimension D (typically 16 inches for a standard H-block) is a dimension which is at least the width of the column and has a tolerance configured to create a snug fit with the column.

Further, in accordance with an embodiment, substantially vertical surface 20 may have a width of dimension C that is configured to extend past the edges of the H-block such that lips 22, 24 may be attached along and/or formed together with the vertical edges of substantially vertical surface 20 and may have a thickness of dimension B. Dimension C, in an embodiment, is approximately 18 inches, resulting in dimension B for lips 22, 24 being approximately one inch. Lips 22, 24 may further have a length of dimension G, which, in an embodiment, is approximately 2.25 inches. It should be understood that for an H-Block having dimensions D and F, it is possible to provide lips 22, 24 having a dimension B that is larger and/or smaller than approximately one inch.

Additionally, in an embodiment, substantially vertical surface 20 may have a thickness of dimension E, and substantially horizontal surface A may have a thickness of dimension A. Dimensions A and E may be configured to provide the desired forces for providing structural support to column 30 and/or to provide sufficient forces to retain veneer panel 10 on column 30. For example, dimension A may be increased to increase the mass of material that comprises substantially horizontal surface 15 in order to increase the vertical force exerted by veneer panel 10 on column 30, which results in an increased force to maintain veneer panel 10 on column 30. Similarly, dimension E may be increased or decreased depending on the characteristics of veneer panel 10 and/or column 30. In an embodiment, dimension A is approximately two inches and dimension E is approximately one inch. In a further embodiment, dimension A is a minimum of two inches, and dimension E is a minimum of one inch.

Various materials may be used to construct the veneer panel 10. For example, the veneer panel may be made of wood, steel, cementatious material (as is used in the manufacture of synthetic or faux stone), carbon fiber, fiberglass, polystyrene, polyurethane and/or a composite of such materials. In other embodiments, the veneer panel may be made of any material now known or hereafter developed that is capable of being molded. In an exemplary embodiment, the veneer panel comprises a mixture of cement, industrial grade fiber (for example, polypropylene, glass, and the like) and a polymer admixture (for example, acrylic liquid such as Acryl-60). Filler material may comprise materials such as polystyrene, pumice, perlite, vermiculite, scoria, and the like. In certain embodiments, lightweight filler material may be used in a proportion or in such a way that the filler material does not weaken the surface hardness of the finished product. In some embodiments, steel reinforcement may be used, for example, in the form of wire mesh.

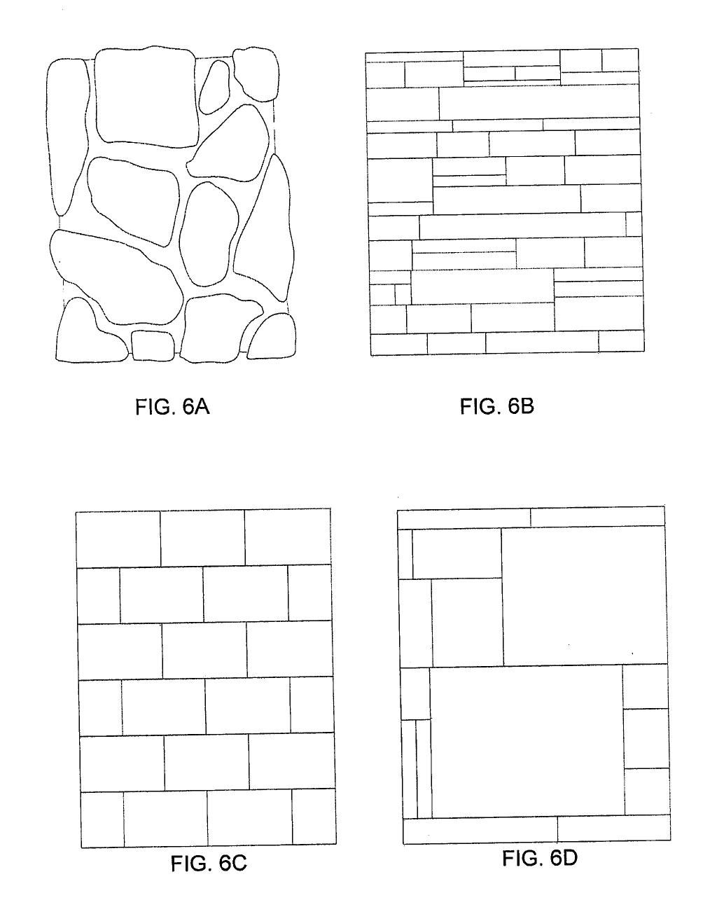

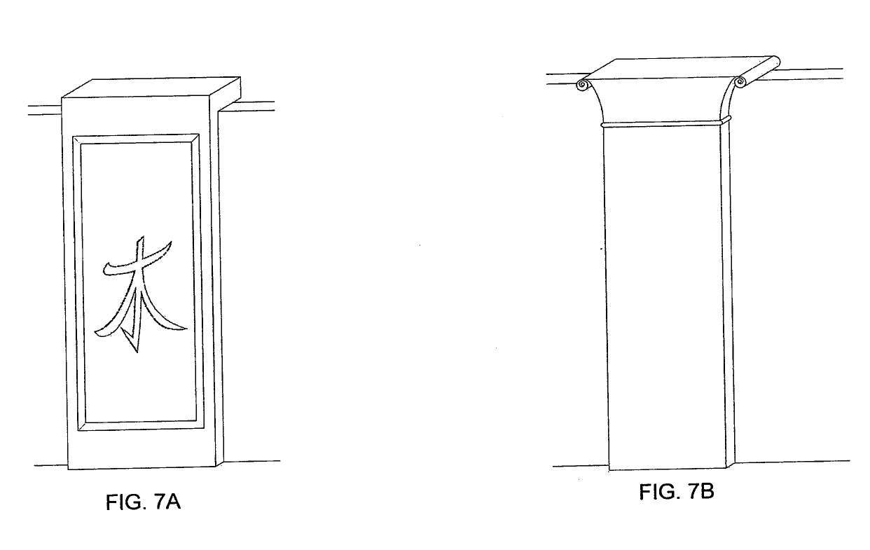

In still other embodiments, the veneer panel 10 may be made out of any other material that is capable of being formed or constructed into an L-shape as discussed above. For example, with reference to FIGS. 6A-6D, individual stones (natural, faux, synthetic, and the like), stucco, cement, concrete, wood, bamboo, tile, and other materials may be shaped into a veneer panel having the configuration disclosed herein. In other embodiments, and with reference to FIGS. 7A-7B, veneer panel 10 may include a pattern that is engraved, embossed, or otherwise provided in veneer panel 10, and/or veneer panel 10 may be configured to resemble a Greek column. Various dimensions of veneer panel 10 may be increased and/or decreased to provide desired forces and/or support depending on the type of material that is used.

An exemplary method for forming the veneer panel will now be disclosed. This method is directed to molding the veneer panel, but it should be understood that any manufacturing method that results in a panel as disclosed herein is within the scope of the present invention.

The first mold encasement is configured to produce a desired shape for the veneer panel 10 and resembles three sides of a long box, but with flanges so it may be attached to the second mold encasement. The first mold encasement may be configured to provide a desired texture to the resulting veneer panel. In other embodiments, a rubber mold may be placed within the first mold encasement to produce certain textures for the veneer panel 10. The second mold encasement is configured to have the same dimensions as the wall itself, including the wall column and may be configured to mimic the dimensions of a typical cinderblock column. The molding material is then poured and/or placed in the first mold encasement, and the second mold encasement is secured to the first mold encasement via the flanges on the first mold encasement. The resulting assembly is configured to sandwich the mold and the cementatious material inside, thus compressing the material and making it stronger and forming the desired shape for the veneer panel.

Exemplary embodiments of the present invention allow for easier installation than existing veneer panels. Veneer panels 10 according to the present invention may not require professional installation. An exemplary method of installation of a veneer panel configured to cover a cinderblock wall column comprises four steps. First, using a masonry blade, cut a portion off the bottom of the veneer panel so that its height matches the height of the cinderblock wall. Second, remove the existing top capstone block from the column and any other grout that remains, for example, using a hammer and a chisel. Third, if desired (to deter theft or accidental removal, for example), apply liquid nails or other adhesive to the inside of the veneer panel. Fourth, position the veneer panel into place, ensuring maximum horizontal and vertical contact with the wall column.

As noted above, for existing brick-by-brick or panel installations, much cutting, mortaring, attaching and mixing of materials may be required. According to embodiments of the present invention, however, installation is simplified. For example, cinderblock columns have standard dimensions for width (16″ typ.) and the degree to which they protrude from the cinderblock wall (2″ typ.). As such, embodiments of the invention comprise pre-formed veneer panels that are configured to fit these standard dimensions. Cinderblock walls may be designed at different heights, so the pre-formed veneer panels may be configured to be as tall as the tallest typically constructed cinderblock wall (or panels of certain lengths may be provided). Installation of the pre-formed panel may then comprise cutting off the bottom portion of the veneer panel so that it matches the height of a particular cinderblock wall.

As noted above, exemplary embodiments of the present invention comprise one piece, which makes installing the veneer panel simpler than brick-by-brick or existing methods of panel installation, and may not require professional installation. Additionally, installation of the veneer panels of the present invention may be faster and more efficient than installation of existing veneer panels. For example, cutting existing veneer panels to fit on an H-block would require substantially more time, materials, skill and cost than installing a one-piece, L-shaped veneer panel according to embodiments of the present invention. Furthermore, cutting existing materials and installing them on an H-block may create structural deficiencies in the H-block (e.g., undesirable moment of force at the base of the H-block column). Even if cutting existing panels and installing them on an H-block were not to result in structural deficiencies, the difficulty, complexity, and cost of such installation would weigh against the use of such methods.

According to further embodiments, veneer panels of the present invention may provide other advantages over brick-by-brick construction. For example, typical faux stone “corner pieces” do not currently extend around the corner far enough (only 1.5″), whereas veneer panels according to the present invention are configured at a full 2.25″ to be adjacent to the wall. Also, materials used in various embodiments of the present invention may be tougher than existing light-weight stone and/or brick veneer, such that they can actually handle getting scratched by a screw driver or accidentally hit with a shovel.

In addition to those benefits and advantages over the prior art that have already been discussed, veneer panels according to embodiments of the present invention are configured to provide many other benefits and advantages. For example, the stability of veneer panel 10 is advantageously arrived at based at least in part on its shape, which is designed to contact three vertical surfaces of an H-block column and one horizontal surface, or the top of the column. The shape itself, like that of an I-beam has a high strength to weight ratio (regardless of the material with which the panel is constructed) because the cross section (section A-A, as illustrated in FIG. 4D) provides an area moment of inertia that gives strength and rigidity to the H-block column. As such, the cover may be used not only for aesthetic value but to give or return stability to a column's structure. Even a featureless, flat veneer panel advantageously gives the existing column structural integrity by, for example, increasing the column's overall area moment of inertia and, therefore, its resistance to structural failure that can lead to tipping or falling over.

Further, the upside down L shape (section B-B as illustrated in FIG. 4B), is advantageously configured to provide minimal stress in a horizontal direction and minimal torsion on the base of the column. Instead, the weight of the cover is distributed in a vertical direction, which is the direction that masonry blocks, such as cinderblock H-block columns are meant to bear.

The simplicity of installation for veneer panel 10 overcomes certain difficulties with the prior art because veneer panel 10 may be one piece. The ease, simplicity and the speed of installation is achieved, in particular, when such patterns as red brick are used, that is, masonry patterns that approach the minimal geometry illustrated. This advantage may be achieved because of how light weight the overall panel is, as compared to the weight of installing actual brick on the vertical surface. Furthermore, because of the I-beam-like geometry, the panel will remain rigid and provide additional strength that prior art veneer installations are not capable of providing. This strength and rigidity may manifest itself by utilizing materials that provide for an even thinner application than is shown as the minimal geometry (e.g., dimensions A, B, and E as illustrated in FIGS. 5A-5D). Furthermore, a tougher material (such as a mix of fiber, acrylic resin and cement) can be used rather than the lighter but more brittle material used in existing stone veneer.

It should be understood that various principles of the invention have been described in illustrative embodiments. However, many combinations and modifications of the above-described formulation, proportions, elements, materials, and components used in the practice of the invention, in addition to those not specifically described, may be varied and particularly adapted to specific environments and operating requirements without departing from those principles. Other variations and modifications of the present invention will be apparent to those of ordinary skill in the art, and it is the intent that such variations and modifications be covered by this disclosure.

Although various embodiments are disclosed herein, it should be understood that other embodiments exist which are not disclosed. Further, various embodiments disclosed herein may be used together with other embodiments, so that when “an embodiment” is described, it is not intended to be exclusive of other embodiments unless expressly stated as such. Therefore, although “further embodiments,” “another embodiment,” and the like may be used to describe the various embodiments presented herein, such language is not limiting and/or exclusive of other embodiments. Various combinations of the embodiments presented herein may be used without departing from the scope of the present disclosure.

Additionally, benefits, other advantages, and solutions to problems have been described herein with regard to various embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

I claim:

1. A veneer panel for an H-block column having a column width and a column height, the veneer panel comprising:
a substantially vertical surface configured to abut a first vertical surface of the H-block column and extend approximately a dimension A past a top of the H-block column, wherein the substantially vertical surface is configured to be longer than the column height by approximately the dimension A, wherein the substantially vertical surface has a thickness of approximately a dimension E, and wherein the substantially vertical surface has a width of approximately a dimension C;
a substantially horizontal surface attached to the substantially vertical surface, wherein the substantially horizontal surface abuts a top of the H-block column and extends from the substantially vertical surface by approximately a dimension F, and wherein the substantially horizontal surface has a thickness of approximately a dimension A;
a first substantially vertical lip attached to a first vertical edge of the substantially vertical surface and configured to abut a second vertical surface of the H-block column, wherein the first substantially vertical lip extends from the substantially vertical surface by approximately a dimension G, and wherein the first substantially vertical lip has a thickness of approximately a dimension B; and
a second substantially vertical lip attached to a second vertical edge of the substantially vertical surface and configured to abut a third vertical surface of the H-block column, wherein the second substantially vertical lip extends from the substantially vertical surface by approximately the dimension G, wherein the second substantially vertical lip has a thickness of approximately the dimension B, and wherein the first substantially vertical lip is separated from the second substantially vertical lip by approximately a dimension D.

2. The veneer panel of claim 1, wherein the dimension A is approximately two inches.

3. The veneer panel of claim 2, wherein the dimension B is approximately one inch.

4. The veneer panel of claim 3, wherein the dimension C is approximately eighteen inches.

5. The veneer panel of claim 4, wherein the dimension D is approximately sixteen inches.

6. The veneer panel of claim 5, wherein the dimension E is approximately one inch.

7. The veneer panel of claim 5, wherein the dimension E is a minimum of one inch.

8. The veneer panel of claim 6, wherein the dimension F is approximately eight inches.

9. The veneer panel of claim 8, wherein the dimension G is approximately 2.25 inches.

10. The veneer panel of claim 1, wherein an H-block in the H-block column has a width of approximately 16 inches and a thickness of approximately 8 inches.

11. A veneer panel for an H-block column, the veneer panel comprising:
a substantially vertical surface abutting a first surface of the H-block column;
a substantially horizontal surface connected to the substantially vertical surface and abutting a second surface of the H-block column;
a first substantially vertical lip attached to a first vertical edge of the substantially vertical surface and configured to abut a third surface of the H-block column; and
a second substantially vertical lip attached to a second vertical edge of the substantially vertical surface and configured to abut a fourth surface of the H-block column, wherein the substantially vertical surface, the substantially horizontal surface, the first substantially vertical lip, and the second substantially vertical lip are molded in one piece and are operatively coupled in order to cause a moment of force at the base of the H-block column to be less than the moment of force would be without at least one of the substantially horizontal surface, the first substantially vertical lip, and the second substantially vertical lip, and wherein the substantially vertical surface, the substantially horizontal surface, the first substantially vertical lip, and the second substantially vertical lip are molded in one piece to facilitate ease of installation of the veneer panel.

12. The veneer panel of claim 11, wherein the substantially horizontal surface exerts a vertical force on the H-block column, and wherein the vertical force is configured to act substantially through the center of the H-block column.

13. The veneer panel of claim 12, wherein the substantially vertical surface exerts a horizontal force on the H-block column that increases asymptotically as the distance from the top of the H-block column increases.

14. The veneer panel of claim 13, wherein the substantially vertical surface, the substantially horizontal surface, the first substantially vertical lip, and the second substantially vertical lip are operatively coupled to at least one of maintain or increase a level of an external force to which the H-block column is subjected without failure of the H-block column.

15. The veneer panel of claim 14, wherein the level of the external force to which the H-block column is subjected without failure of the H-block column is greater than it would be without the substantially horizontal surface.

16. The veneer panel of claim 11, wherein the substantially vertical surface, the substantially horizontal surface, the first substantially vertical lip, and the second substantially vertical lip are operatively coupled to increase an area moment of inertia associated with the H-block column and the veneer panel.

17. The veneer panel of claim 11, further comprising a second substantially vertical surface abutting a fifth surface of the H-block column, wherein the second substantially vertical surface is substantially parallel to the substantially vertical surface, and wherein the surfaces of the veneer panel comprise a U-shape.

18. The veneer panel of claim 11, wherein the surfaces of the veneer panel comprise an L-shape.

19. A method of manufacturing a veneer panel, comprising:
forming a first mold encasement configured to provide a desired texture of the veneer panel, wherein the mold encasement is dimensioned in accordance with a top and a side of a cinderblock H-block column, and wherein the first mold encasement is configured to produce a substantially vertical surface, a substantially horizontal surface, a first substantially vertical lip, and a second substantially vertical lip of the veneer panel;
placing a molding material into the first mold encasement;
securing a second mold encasement to the first mold encasement to facilitate forming the veneer panel, wherein the veneer panel is configured to be hung on the cinderblock H-block column in order to increase a column area moment of inertia of the cinderblock H-block column.

20. The method of claim 19, wherein the molding material and the first mold encasement are configured to form a veneer panel texture resembling at least one of brick, stone, wood, stucco, concrete, bamboo, and tile.
